(19) United States
(12) Patent Application Publication
(10) Pub. No.: US 2015/0291470 A1
(43) Pub. Date: Oct. 15, 2015

(54) METALLIC SURFACES BY METALLOTHERMAL REDUCTION

(71) Applicant: Corning Incorporated, Corning, NY (US)

(72) Inventors: Nicholas Francis Borrelli, Elmira, NY (US); Indrajit Dutta, Horseheads, NY (US); Shawn Michael O'Malley, Horseheads, NY (US); Vitor Marino Schneider, Painted Post, NY (US)

(21) Appl. No.: 14/751,202

(22) Filed: Jun. 26, 2015

Related U.S. Application Data
(63) Continuation-in-part of application No. 13/693,453, filed on Dec. 4, 2012.
(60) Provisional application No. 61/569,457, filed on Dec. 12, 2011.
(60) Provisional application No. 62/017,403, filed on Jun. 26, 2014.

(51) Int. Cl. C03C 17/06; C03C 21/00; C03C 15/00

(52) U.S. Cl. CPC C03C 17/06; C03C 15/00; C03C 21/00; C03C 2217/256; C03C 2218/33

(57) ABSTRACT

Methods of forming metal coatings by metallothermal reduction from metal oxide-containing glasses and glass ceramics are provided. The resulting products have metal surfaces which can be porous and further, have high reflectivities.

### CLAIMING BENEFIT OF PRIOR FILED U.S. APPLICATION

This application is a continuation-in-part of U.S. application Ser. No. 13/693,453, filed on Dec. 4, 2012 which claims priority to U.S. Prov. Appl. Ser. No. 61/569,457 filed on Dec. 12, 2011. This application also claims the benefit of priority under 35 U.S.C. § 119 of U.S. Provisional Application Serial No. 62/017,403, filed on Jun. 26, 2014. The content of this document and the entire disclosure of publications, patents, and patent documents mentioned herein are incorporated by reference.

### FIELD

The present disclosure relates to methods of forming metallic layers on silica-based structures.

### BACKGROUND

There is a growing interest in controlling the properties, particularly the surface properties, of materials. Surface modification has potential uses in a large number of areas, such as in electronics, fuel cells, pH- and other types of sensors, catalysts, and biotechnology. However, the continuing challenge in developing such materials is how to efficiently and effectively produce them.

### SUMMARY

Embodiments are directed to forming metallic coatings on glass surfaces utilizing metallothermic processes.

Herein are described metallothermic processes to create metal coatings on glass and glass ceramics. One embodiment comprises a method of producing metal coated glass or glass ceramic, comprising subjecting a glass or glass ceramic to a metallothermic process; and optionally, removing reaction by-products to give a substantially pure metal coated glass or glass ceramic.

In some embodiments, the subjecting the glass or glass ceramic to a metallothermic process step comprises heating to a temperature of greater than 400° C. for more than 2 hours. In some embodiments, the subjecting the glass or glass ceramic to a metallothermic process step comprises heating to a temperature of greater than 400° C. for more than 2 hours and subsequently, heating to a temperature of greater than 600° C. for more than 2 hours. In some embodiments, the removing reaction by-products comprises acid etching the aerometal.

Additional embodiments are disclosed and claimed.

### BRIEF DESCRIPTION OF THE DRAWINGS

FIG. 1 shows emission spectra of aerosilicon (spectrum “SSA”) and aeroaluminum (spectrum “AA”). The parameters for the aerosilicon sample were excitation at 349 nm with 0.5 nm step size and 1 μm slits used in both the source and the detector. The parameters for the aeroaluminum sample were excitation at 349 nm with 1 nm step size and 2 μm slits used in both the source and the detector.

FIG. 2A is a digital picture of a high Ag-content silica glass (glass code 1960) after magnesiothermal reduction. Prior to the reaction, the glass disk was transparent. The back side of the glass comprises a reacted surface that contains the silver metal reduced from the original glass. FIG. 2B shows a schematic of the glass in profile with the silver layer on one surface.

FIG. 3A shows an HAADF STEM image of the magnesiothermally-reduced surface along with EDS maps of Ag (FIG. 3B) and Si (FIG. 3C). The reduction of the silver compared and silica can be clearly seen wherein the Ag forms a film on the top surface and regions in the sublayer while the crystalline Si was only present in significant amounts in the sublayer.

FIG. 4A provides a second example of a high Ag-content silica glass (glass code 1960) after magnesiothermal reduction. In the second example, both surfaces of the glass formed Ag layers, with the layer facing away from the crucible forming a Ag-nanoparticle surface. FIG. 4B is a profile schematic showing the formed silver layers.

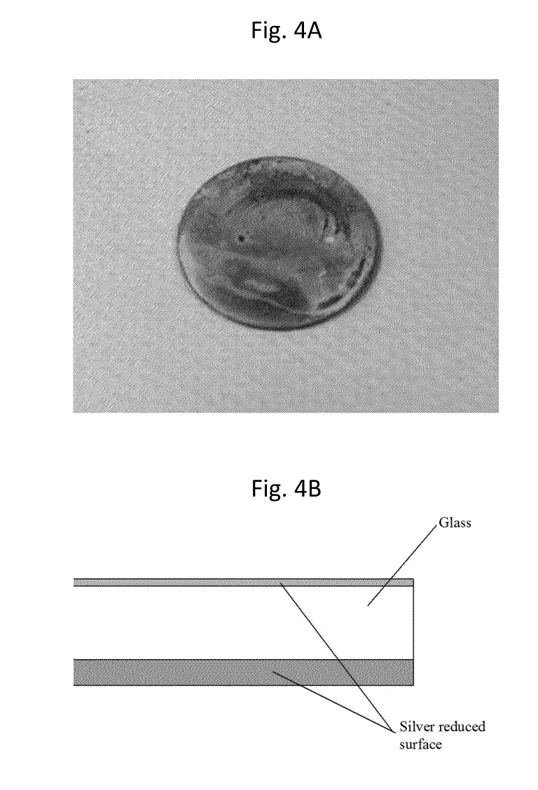

FIG. 5A shows a HAADF STEM image of the top side of the sample in FIG. 4A—the side opposite the magnesiothermally reduced surface. The image shows a layer of reduced Ag nanoparticle droplets. EDS maps of Ag (FIG. 5B) and Si (FIG. 5C) provide a clear picture of the delineation between the Ag and Si.

### DETAILED DESCRIPTION

The present disclosure can be understood more readily by reference to the following detailed description, drawings, examples, and claims, and their previous and following description. However, before the present compositions, articles, devices, and methods are disclosed and described, it is to be understood that this description is not limited to the specific compositions, articles, devices, and methods disclosed unless otherwise specified, as such can, of course, vary. It is also to be understood that the terminology used herein is for the purpose of describing particular aspects only and is not intended to be limiting.

The following description is provided as an enabling teaching. To this end, those skilled in the relevant art will recognize and appreciate that many changes can be made to the various aspects described herein, while still obtaining the beneficial results. It will also be apparent that some of the desired benefits can be obtained by selecting some of the features without utilizing other features. Accordingly, those who work in the art will recognize that many modifications and adaptations to the present embodiments are possible and can even be desirable in certain circumstances. Thus, the following description is provided as illustrative and not in limitation thereof.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings^{.}

“Include,” “includes,” or like terms means encompassing but not limited to, that is, inclusive and not exclusive.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

“Metallothermic,” as used herein, refers to a gas/solid displacement reaction wherein at least one solid oxide compound is at least partially converted to the base element or an alternative compound comprising the base element via reaction with a gas. In some embodiments, the gas comprises Mg or Ca.

“Phase-separated glasses” and “phase-separated glass ceramics,” as used herein, refers to glasses and glass ceramics that are separated into at least two compositionally different phases. For example, borosilicate glasses in certain composition regions tend to separate into a silica-rich phase, and a borate-rich phase upon heat treatment. In some borosilicate glass compositions, the silica-rich phase is continuous, while the borate-rich phase is either continuous at sufficiently high borate concentrations, or at low borate concentrations, the borate-rich phase may be incorporated in the form of colloids in the major silica-rich phase.

“Aerometal” or “aero[element],”as used herein, refers to an aerogel that has undergone metallothermic processing and at least part of one oxide component has been converted to the base element. For example, “aerosilicon” comprises a metallothermically processed silica aerogel wherein the silica has been at least partially converted to silicon. “Aeroaluminum” comprises a metallothermically processed alumina aerogel wherein the alumina has been at least partially converted to aluminum.

There are several techniques that are used to deposit a thin film of metal coatings, like silver, onto a piece of glass. Some examples include thermal evaporation, sputter deposition, plasma assisted deposition, e-beam evaporation and others. While these prior mentioned techniques can be used with almost any metal, it is the conditions of deposition such as temperature that may not be compatible with the softening point of the target glass. The present techniques of exposing a metal ion containing glass to a reducing metallic gas can be used to form a thin layer of metal or pockets of metal clusters dispersed at the surface of the glass surface at reaction temperatures as low as about 660° C. Further, the disclosed processes are also compatible with metals that are difficult to evaporate or rare to find in metal form. The formed surfaces are useful for many applications, including electronics, fuel cells, pH- and other types of sensors, catalysts, and biotechnology.

Where the term glass is used herein, it is intended that glass ceramics or glasses that can be made into glass ceramics are also considered.

The current disclosure expands the scope of processes available for the manufacturing of unique coated glass structures. Many glasses include additional metal oxides that can be particularly useful when available at the glass surface. Current embodiments disclose cheap, efficient and powerful ways to manufacture glass substrates with metallic coatings. In some aspects, the structures comprise highly porous phase separated glasses or glass ceramics that may be used in numerous applications. In other embodiments, the glasses are non-porous and the metallic coating is essentially continuous on at least part of one surface.

In one embodiment, the composition comprises a glass or glass ceramic substrate having an essentially continuous metallic coating on at least part of one surface . In some embodiments, the metallic coating comprises a transition metal. In some embodiments, the metallic coating comprises a lanthanide- or actinide-series metal. In some embodiments, the metallic coating comprises B, Si, Al, Sc, Ti, V, Cr, Mn, Fe, Co, Ni, Cu, Zn, Ga, Ge, As, Se, Y, Zr, Nb, Mo, Tc, Ru, Rh, Pd, Ag, Cd, In, Sn, Sb, Te, Lu, Hf, Ta, W, Re, Os, Ir, Pt, Au, Tl, Pb, Bi, Po, La, Ce, Pr, Nd, Pm, Sm, Eu, Gd, Tb, Dy, Ho, Er, Tm, or Yb, or combinations thereof. In some embodiments, the metallic coating comprises Ag, Pt, Pd, Ru, Cu, Co, Ni, Cr, W, Re, Sn, Au, Ti, and combinations thereof.

Base starting glasses or glass ceramics can be any glass or glass ceramic comprising a metal oxide of the desired metal at a concentration sufficient to produce the metal coating. In some embodiments, the metal oxide should be present in an amount from about 5 mol % to about 25 mol %. In some embodiments, the metal oxide should be present in the glass or glass ceramic composition in an amount from about 10 mol % to about 25 mol %, about 15 mol % to about 25 mol %, about 20 mol % to about 25 mol %, about 5 mol % to about 20 mol %, about 10 mol % to about 20 mol %, about 15 mol % to about 20 mol %, about 5 mol % to about 15 mol %, about 10 mol % to about 15 mol %, or about 5 mol % to about 10 mol %.

Alternatively, the metal oxide may be non-homogenously present in the glass, and in particular, may be present in higher concentrations near one or more of the surfaces of the glass. For example, the metal oxide may be present at higher concentrations due to ion exchange, application of an electric field, thermal or chemical reaction, etc. In such embodiments, the concentration of the metal oxide in the starting glass or glass ceramic can be from 0 mol % to about 25 mol % as a function of proximity to the surface and further, the concentration of the metal oxide may vary in a linear or nonlinear fashion as a function of depth. In some embodiments, the concentration of the transition metal-oxide in the glass or glass ceramic varies by ±50% or less or ±25% or less as a function of proximity to the surface

In another alternative, the glass or glass ceramic may comprise a phase-separated glass or phase-separated glass ceramic. In such embodiments, it is possible that one phase comprises more or all of the metal oxide which is intended to form the coating layer. Further, it is possible in instances where the coating is intended to comprise an alloy or more than one metal, that the metal oxide precursors are non-linearly distributed across the various phases of the glass or glass ceramic. In such instances, it is possible that the resulting metal coating will comprise nano- to micro-scale regions of texture or roughness.

In some embodiments, the metal is present as an ion rather than a metal oxide. In such instances, the concentration of the metal within the glass may be controlled by ion exchange, application of an electric field, thermal or chemical reaction, etc.

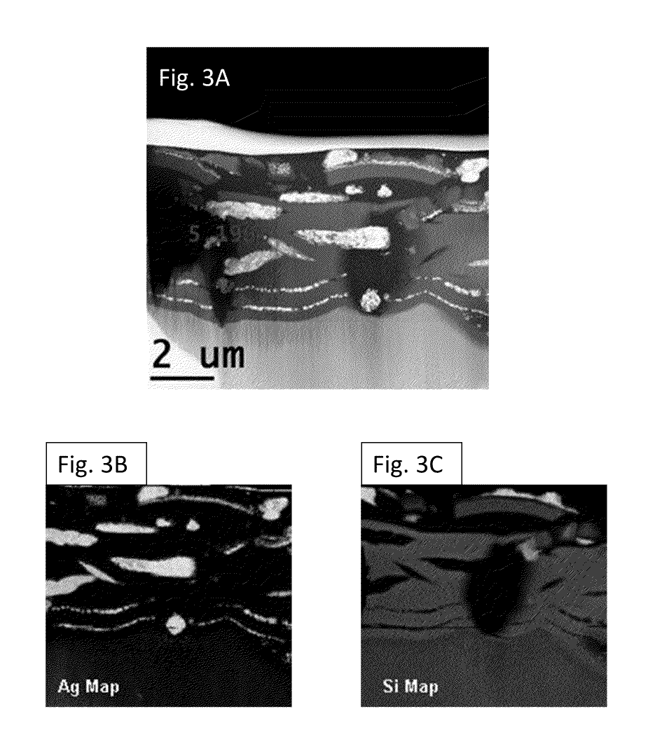

In addition to the metal coating formed on one or more surfaces of the starting material, it is possible to obtain inhomogenous sublayers that can comprise silicon, silica, and the metal. FIG. 3A is a micrograph showing sublayers of silicon and silver present under the silver coating. By controlling metal concentration and location, it is possible to obtain structures where the sublayer(s) comprise different metals than the surface and/or bulk.

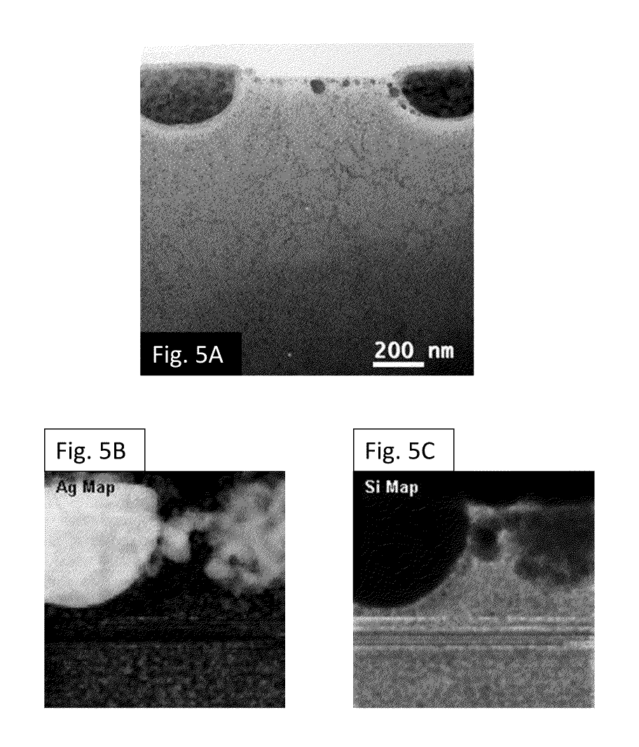

Depending on the reaction time, metal oxide concentration, metal oxide, glass characteristics, reaction temperature, and Mg concentration, the formed metal coating can have a number of different properties. In addition to forming metal coatings, the processes described herein can be used to form textured glass surfaces or textured metal surfaces on glass (or glass ceramic). FIGS. 5A-5C show a surface having an inhomogeneous structure due to process conditions. The resulting surface is composed of nanoscale silver spheres providing a textured surface. Such a surface could be useful for spectroscopy, catalysis, and the like. Further, the silver (or other metal) could be etched off, providing a roughened glass surface that could be optimized for light scattering in any number of processes.

The coatings are generally found to be nonporous or have very low porosity. However, in some embodiments where the starting material is porous, it is possible to obtain metal coatings with high surface areas and/or are porosities. In some embodiments, the coatings has a surface area from about 20 to about 200 m²/g. In some embodiments, the coatings has an average pore size of from about 0.4 nm to about 100 nm.

As an example of one embodied process comprises the reaction of a general metal or metalloid oxide substrate and metallothermic reduction via Mg gas. However, as noted previously, the scope of the present disclosure extends beyond specific metallothermic reduction processes. More specifically, according to embodiments described herein, an metal- or metalloid-based structure comprising a porous metal or metalloid layer can be fabricated by extracting oxygen from the atomic elemental composition of a metal or metalloid oxide. The metal or metalloid oxide substrate may comprise any metal or metalloid element, such as, but not limited to, silicon, aluminum, iron, copper, boron, or combinations thereof. Oxygen is extracted from the metal or metalloid oxide substrate by reacting a metallic gas, such as Mg, with the metal or metalloid oxide substrate in a heated inert atmosphere to form a metal-oxygen complex along a surface of the metal or metalloid oxide substrate.

To facilitate the oxygen extraction, the inert atmosphere is heated to a reaction temperature T, which, in the case of many metal or metalloid oxide substrates, will be between about 400° C. and about 900° C. For example, and not by way of limitation, for alkaline earth alumina borosilicate glass, a suitable reaction temperature T will be approximately 675° C. or slightly less and can be maintained for approximately two hours. In some embodiments, the reaction temperature is about 400° C., 425° C., 450° C., 475° C., 500° C., 525° C., 550° C., 575° C., 600° C., 625° C., 650° C., 675° C., 700° C., 725° C., 750° C., 775° C., 800° C., 825° C., 850° C., 875° C., or 900° C. In most cases, the metal or metalloid oxide substrate can be characterized by a thermal strain point and the inert atmosphere can be heated to a reaction temperature below the thermal strain point of the metal or metalloid oxide substrate. For example, and not by way of limitation, for glass having a strain point of about 669° C., the inert atmosphere can be heated to about 660° C. Reduced reaction temperatures are contemplated for low pressure reaction chambers.

Ramp rates for heating the precursor components to the reaction temperature can have an effect on the resulting structure. It is generally the case that the resulting pore structure in the hybrid materials is larger with faster ramp rates. As described in FIGS. 9A-9C, when moving from a ramp rate of 40° C./min to 2° C./min, the pores in the resulting hybrid material decrease in size dramatically. This result provides for the ability to “tune” the pore structure to the particular device or system via a simple modification of the process parameters. Ramp rates can be set from 1° C./min to more than 50° C./min, for example 1, 2, 5, 10, 20, 30, 40, 50, 75, or 100° C./min.

The metal or metalloid oxide substrate may comprise any form. In some embodiments the metal or metalloid oxide substrate is a glass, a phase separated glass or glass ceramic. In some embodiments, the glass or glass ceramic comprises oxides of boron, phosphorous, titanium, germanium, zirconium, vanadium, etc.

It is contemplated that a variety of suitable reduction gases can be utilized without departing from the scope of the present disclosure. For example, and not by way of limitation, it is contemplated that the metallic reducing gas may comprise Mg, Ca, Na, Rb, or combinations thereof. In a simplified, somewhat ideal case, where the metallic gas comprises Mg, the corresponding stoichiometric reaction with the silica glass substrate is as follows:

2Mg+SiO₂→Si+2MgO.

Analogous reactions would characteristic for similar reducing gases.

In non-stoichiometric or more complex cases, reaction byproducts like Mg₂Si are generated and the reducing step described above can be followed by the byproduct removal steps described below. Generally, the application of an strong organic acid in water, alcohol, or polar organic solvent will remove the reaction byproducts. However, in some cases, it may be necessary to sonicate or apply a mixing force to remove byproducts adhered to the hybrid materials. In some cases, it is advantageous to centrifuge the resulting materials to separate out byproducts or to size-separate the actual products. Alternatively, to avoid byproduct generation and the need for the byproduct removal step, it is contemplated that the stoichiometry of the reduction can be tailored such that the metallic gas is provided in an amount that is not sufficient to generate the byproduct. However, in many cases, the composition of the crystalline precursor will be such that the generation of additional reaction byproducts is inevitable, in which case these additional byproducts can be removed by the etching and thermal byproduct removal steps described herein.

To enhance reduction, the metal or metalloid substrate can be subject to microwave or RF exposure while reacting the metallic gas with the metal or metalloid substrate. The metallic gas can be derived from any conventional or yet to be developed source including, for example, a metal source subject to microwave, plasma or laser sublimation, an electrical current, or a plasma arc to induce metal gas formation. In cases where the metallic gas is derived from a metal source, it is contemplated that the composition of the metal source can be varied while reacting the metallic gas with the metal or metalloid substrate to further enhance reduction.

Additional defects can be formed in the metal or metalloid substrate by irradiating the surface of the substrate with electrons. The resulting defects enable a more facile and extensive extraction of oxygen by the metallothermic reducing gas agent and, as such, can be used to enhance oxygen extraction by subjecting the glass substrate to electron beam irradiation prior to the above-described metallothermic reduction processes. Contemplated dosages include, but are not limited to, dosages from approximately 10 kGy to approximately 75 kGy, with acceleration voltages of approximately 125 KV. Higher dosages and acceleration voltages are contemplated and deemed likely to be advantageous.

The metal-oxygen complex that is formed may be removed to yield a hybrid structure. The end product may be a silicon-silica hybrid with additional, optional dopants present.

Although the various embodiments of the present disclosure are not limited to a particular removal process, it is noted that the metal-oxygen complex can be removed from the surface of the metal or metalloid substrate by executing a post-reaction acid etching step. For example, and not by way of limitation, post-reaction acid etching may be executed in a 1M HCl solution in water and alcohol (molar HCl (conc.): H2O:EtOH (−100%) ratio=0.66:4.72:8.88) for at least 2 hours. Alternate alcohols may also be used in the etching step. Depending on the porosity of the glass, some additional MgO may be trapped inside the glass and additional etching may be needed for longer periods of time with multiple flushes of the acidic mixture.

In embodiments, the disclosure provides a method of producing a coating, comprising:
a. subjecting a metal oxide-containing glass to a metallothermic process; and
b. removing reaction by-products to give a substantially pure metal coating.

In some embodiments of the method, the subjecting the glass to a metallothermic process comprises heating to a temperature of greater than 400° C. for more than 2 hours or subjecting the glass or glass ceramic to a metallothermic process comprises heating to a temperature of greater than 400° C. for more than 2 hours and subsequently, heating to a temperature of greater than 600° C. for more than 2 hours. In some embodiments, the removing reaction by-products comprises acid etching the glass or coating.

In embodiments, the disclosure provides a method of forming a metal coating comprising:
a. providing a metal oxide containing glass;
b. extracting oxygen from the metal oxide by reacting a metallic gas with the substrate in a heated inert atmosphere to form a metal-oxygen complex, wherein the inert atmosphere is heated to a reaction temperature sufficient to facilitate the oxygen extraction; and
c. removing the metal-oxygen complex to yield a nonporous metal coating.

In some embodiments, the surface area of the film is from about 10 to 2000 m²/g. In some embodiments, the coating is formed from a phase separated glass or glass ceramic. In some embodiments, the phase separated glass or glass ceramic comprises a borosilicate glass. In some embodiments, the disclosure provides an article comprising the film.

### EXAMPLES

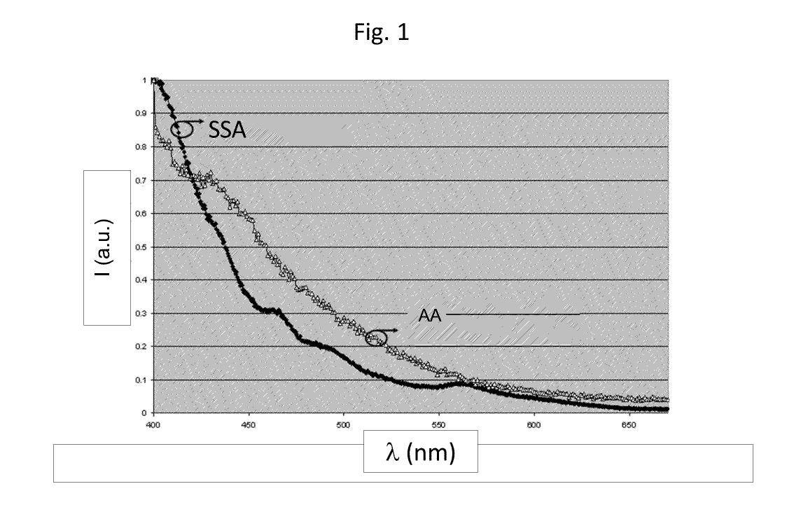

FIG. 1 compares aerosilicon (spectrum “SSA”) to aeroaluminum (spectrum “AA”) and provides evidence that non-silicon metal compounds can be obtained from metallothermic processes. The aeroaluminum presents similar photoluminescence behavior as the silica aerogel. As shown in the figure, the spectral characteristics for aeroaluminum are red shifted, leading to a more warm emission with a white-orange luminescence.

Glass compositions containing high levels of metallic oxides are subjected to metallothermic processes as described herein. A glass disk made of Corning glass code 1960 (comprising approximately 30 mol % silver (Ag) in a silicate glass and having a melting point above 660° C.) is put placed on the mouth of a glassy carbon crucible (crucible opening of around 2 inches) loaded with approximately 15 mg of Mg powder. The crucible, Mg powder and glass are heated to about 660° C. in an low-humidity, argon-filed glove box and maintained at this temperature for about 4 hours. At this temperature, the Mg becomes volatile and attacks the glass surface. Subsequent to the heating, the surface of the glass is baked at 400° C. for about 6 hours. The final step is that the glass surface is etched with an organic acid mixture (e.g., 1M HCl solution (molar HCl: H₂O: EtOH ratio=0.66:4.72:8.88).

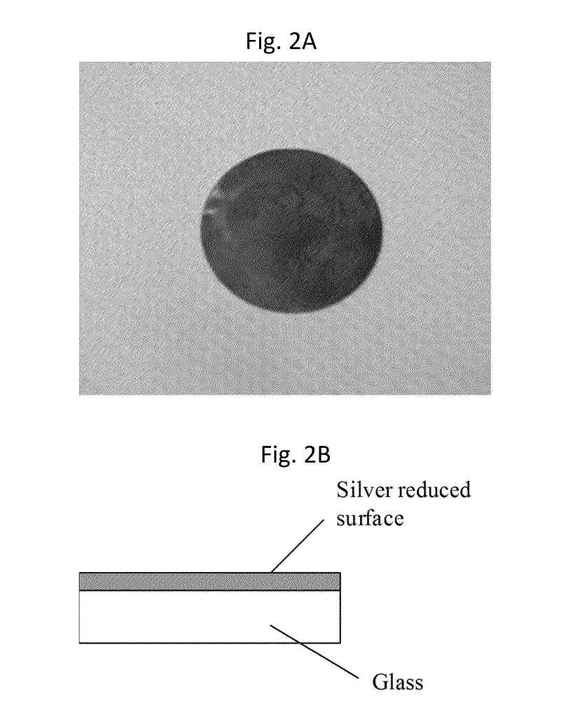

The resulting product was tested via X-ray diffraction and showed peaks for both silicon and silver. FIG. 2A is a digital image of the reacting side of the glass disk after reaction, baking and etching steps, while FIG. 2B is a schematic showing the profile image of the disk. The presence of dark color in FIG. 2A indicates a deep reduction of the surface. The resulting product was shown to have a mirror-like surface quality (FIG. 2A). FIG. 3A presents a high-angle annular dark field (HAADF) scanning transmission electron microscope (STEM) image of a thin Focused Ion Beam (FIB) section of the surface in FIG. 2. The HAADF image also provides a Z-contrast image indicating elements with higher atomic number will be brighter than the rest. From the image, one can observe the metallothermic reduction of the silver-containing glass. The layered structure at the surface of the glass as shown in FIG. 3A and indicates that the Mg gas is reducing the Ag preferentially over the silica. The total layer is ˜5 μm. EDS images confirm that only the top silica layer (100) has been converted to metallic Si. Below the Ag layer are shown a number of silica sublayers with regions of Ag present (110) in FIG. 3A.

A second sample was exposed to metallothermic reduction, baking, and etching. In this second sample, the both surfaces formed Ag layers, even though the surface facing away from the crucible was not intentionally exposed to Mg gas. FIG. 5A shows a HAADF image the glass surface facing away from the reaction vessel—i.e., the glass surface not intentionally exposed to Mg gas. Although the initial notion is that this surface is would primarily be glassy, Z-contrast imaging shows that this surface has ˜200 nm layer of Ag droplets. A closer look at the different regions of the top surface is shown in FIGS. 5B and 5C. Interestingly, FIG. 5C shows that Ag nanoparticles are reduced in the bulk glass as well showing the network structure of the metal. While not wanting to be bound to any particular theory, it is possible that the Mg gas may have percolated through the cover glass during the reduction process and started reducing the far surface. If so, it is indicative that the Ag layer thickness can be controlled by both the exposure time and the concentration of Mg gas.

The disclosed techniques and embodiments of surface layer modification can have profound implications in many surface applications, such as anti-bacterial, anti-fingerprint, anti-glare, mirrors, reflectors, etc.

1. A method of forming a metal coated glass or glass ceramic comprising:
a. subjecting a transition metal oxide-containing glass to a metallothermic process to obtain a glass product; and
b. removing reaction by-products from the glass product to give a substantially pure metal coating;
wherein the total mol % of transition metal-oxides present in the glass or glass ceramic is from about 10 mol % to about 25 mol %.

2. A method of forming a metal coated glass or glass ceramic comprising
a. providing a transition metal oxide-containing glass or glass ceramic;
b. extracting oxygen from the metal oxide by reacting a metallic gas with the substrate in a heated inert atmosphere to form a metal-oxygen complex, wherein the inert atmosphere is heated to a reaction temperature sufficient to facilitate the oxygen extraction; and
c. removing the metal-oxygen complex to yield a nonporous metal coating;
wherein the total mol % of transition metal-oxides present in the glass or glass ceramic is from about 10 mol % to about 25 mol %.

3. The method of claim 1, wherein the transition metal oxide comprises Ag, Pt, Pd, Ru, Cu, Co, Ni, Cr, W, Re, Sn, Au, Ti, and combinations thereof.

4. The method of claim 1, wherein the glass or glass ceramic is phase separated.

5. The method of claim 1, wherein the concentration of the transition metal-oxide in the glass of glass ceramic is non-homogeneous.

6. The method of claim 5, wherein the concentration of the transition metal-oxide in the glass or glass ceramic is greater near the surface of the glass than in the bulk.

7. The method of claim 6, wherein the concentration of the transition metal-oxide in the glass or glass ceramic changes linearly.

8. The method of claim 6, wherein the concentration of the transition metal-oxide in the glass or glass ceramic changes nonlinearly.

9. The method of claim 5, wherein the concentration of the transition metal-oxide in the glass or glass ceramic varies by ±50% or less as a function of proximity to the surface.

10. The method of claim 9, wherein the concentration of the transition metal-oxide in the glass or glass ceramic varies by ±25% or less as a function of proximity to the surface.

11. The method of claim 1, further comprising the step of subjecting the glass or glass ceramic to ion exchange, application of an electric field, thermal conditions or chemical reaction prior to or after subjecting the glass or glass ceramic to a metallothermic process or metallic gas.

12. The method of claim 1, wherein the non-porous metal coating has a thickness of from about 200 nm to about 5 μm.

13. The method of claim 12, wherein the non-porous metal coating comprises Ag, Pt, Cu, Ni, W, Au, Ti, and combinations thereof.

14. The method of claim 1, wherein the subjecting a transition metal oxide-containing glass to a metallothermic process comprises heating the transition metal oxide-containing glass to a temperature between about 400 and 700° C.

15. The method of claim 1, wherein the removing reaction by-products from a glass product to give a substantially pure metal coating comprises etching the glass product in an organic acid.
